(19) United States
(12) Patent Application Publication
(10) Pub. No.: US 2011/0041940 A1
(43) Pub. Date: Feb. 24, 2011

(54) SEAMLESS FAUCET AND A MANUFACTURING METHOD THEREOF

(76) Inventor: CHIN-TSAI LEE, Hsien Hsi Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/545,198

(22) Filed: Aug. 21, 2009

(51) Int. Cl. F16K 21/00; B23K 37/00

(52) U.S. Cl. 137/801; 228/140

(57) ABSTRACT

A manufacturing method of a seamless faucet has following steps: punching to shape a cover and a dispersing base respectively; welding a threaded connector at a center of the cover and welding an insertion on the dispersing base; selectively polishing surfaces of the cover; optionally arranging a resilient pad and a guiding plate inside the dispersing base; combining the cover and the dispersing base and then welding into a body in one-piece; and polishing and electroplating the body to eliminate the seam to obtain the seamless faucet that has low manufacturing cost, thin thickness and stylish appearance.

### BACKGROUND OF THE INVENTION

1. Field of the Invention

The present invention relates to a seamless faucet and a manufacturing method thereof, and more particularly to a seamless faucet that has a thin thickness and a shining smooth surface and its manufacturing method.

2. Description of Related Art

As modern people paying more attention to sense of beauty and style, various articles in daily life are not only manufactured in focus of functional applications but also of its size and excellent appearance to promote sales. Therefore, a stylish thin shower faucet is marketed commercially, which controls proportions of cold water and hot water by driving a handle to make the mixed water to spray out via a showing head or spraying holes for shower.

The conventional thin faucet is manufactured by forging a cover and a dispersing base respectively in initial manufacturing procedure. The cover has a locking hole thereon and has a connector head welded at its center. The dispersing base has a threaded recess to align with the locking hole. After aligning the cover and the dispersing base, a locking element penetrates the locking hole on the cover and secured with the threaded recess on the dispersing base to complete the thin faucet. However, the conventional thin faucet has high costs in respect of manufacturing, material and processing fee. Moreover, thickness of the conventional thin faucet cannot reach an ideal one because the cover and the dispersing base are forged respectively and secured by the locking element. Additionally, the seam between the cover and the dispersing base is visible and the locking element has its end emerging out of the faucet, thus the seam and the emerged end both make the thin faucet a poor and unpleasant appearance.

### SUMMARY OF THE INVENTION

A main objective of the present invention is to provide a seamless faucet that has low cost in respect of manufacture, raw material and process.

Another main objective of the present invention is to provide a seamless faucet that is made by welding into one-piece to diminish thickness to have super thin and light weight.

A further main objective of the present invention is to provide a seamless faucet that has stylish and excellent shiny appearance.

To achieve the foregoing objectives, the manufacturing method of the seamless faucet comprises:

punching to shape a cover and a dispersing base respectively;

welding a threaded connector to mount on the cover and welding an insertion with multiple inlets to mount on the dispersing base;

polishing a surface of the dispersing base;

arranging a resilient pad and a guiding plate with multiple nozzles inside the dispersing base;

combining the cover and the dispersing base by screwing the insertion with the threaded connector to achieve an initial combination, which is clamped by tools, and welding the cover and the dispersing base into a body in one-piece;

polishing the body composed of the cover and dispersing base;

electroplating the body composed of the cover and dispersing base to obtain the seamless faucet.

The seamless faucet having the foregoing objectives comprises:

a cover having a top surface and a threaded connector welded to mount at a center of the top surface of the cover; and

a dispersing base having a top surface and a insertion welded to mount at a center of the top surface of the dispersing base to engage the threaded connector on the cover by thread-screwing;

wherein the cover and the dispersing base are further welded to combine into a body in one-piece after thread-screwing and the body is further polished and electroplated.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a manufacturing method of a seamless faucet in accordance with the present invention;

FIG. 2 is an exploded perspective view of the seamless faucet in accordance with the present invention;

FIG. 3 is a perspective view of the seamless faucet after combining a cover and a dispersing base and before polishing;

FIG. 4 is a perspective view of the seamless faucet after polishing;

FIG. 5 is a side view of the seamless faucet in FIG. 4;

FIG. 6 is a flow chart of another embodiment of the manufacturing method of a seamless faucet in accordance with the present invention;

FIG. 7 is an exploded perspective view of the seamless faucet manufactured according to the flow chart in FIG. 6; and

FIG. 8 is a side view of the seamless faucet in FIG. 7.

### DETAILED DESCRIPTION OF THE PREFERRED EMBODIMENT

A manufacturing method of a seamless faucet has following steps: punching to shape a cover and a dispersing base respectively; welding a threaded connector at a center of the cover and welding an insertion on the dispersing base; selectively polishing surfaces of the cover; optionally arranging a resilient pad and a guiding plate inside the dispersing base; combining the cover and the dispersing base and then welding into a body in one-piece; and polishing and electroplating the body to eliminate the seam to obtain the seamless faucet that has low manufacturing cost, thin thickness and stylish shiny appearance.

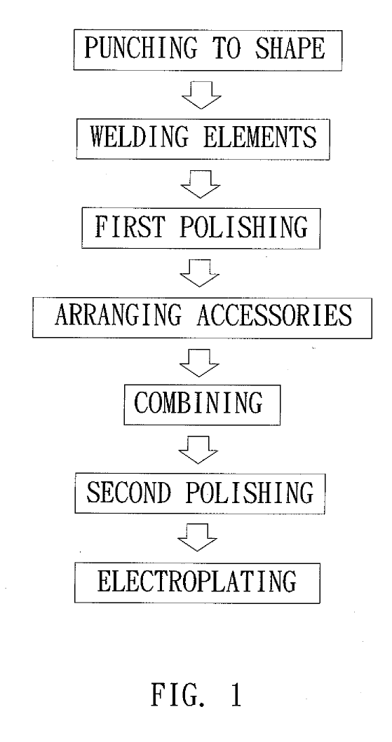

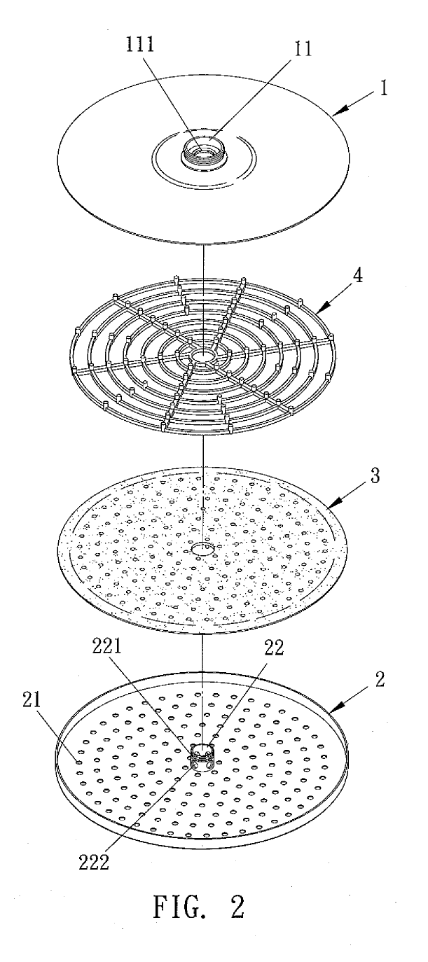

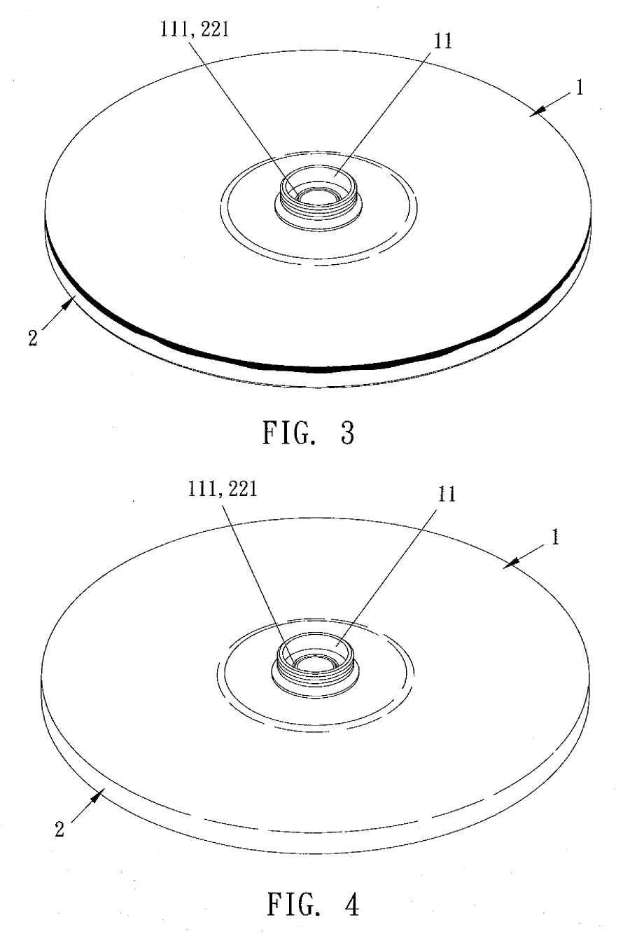

A preferred embodiment of a manufacturing method of a seamless faucet is shown in FIGS. 1 to 3, which has the following steps:

punching to shape: a cover 1 and a dispersing base 2 with multiple water holes 21 are shaped by punching respectively;

welding elements: a threaded connector 11 with an inner thread 111 is mounted on the cover 1 by welding and an insertion 22 with an outer thread 221 and multiple inlets 222 defined on its sidewall is mounted on the dispersing base 2 by welding;

first polishing: polishing surface of the dispersing base 2 to shine the surface;

arranging accessories: a resilient pad 3 with multiple holes (not numbered) and a guiding plate 4 with multiple nozzles (not numbered) are optionally arranged inside the dispersing base 2, wherein the holes, the nuzzles and the water holes 21 on the dispersing base 2 are in alignment;

combining: by screwing the outer thread 221 on the insertion 22 with the inner thread 111 on the threaded connector 11, the cover 1 and the dispersing base 2 are combined to achieve an initial combination and then clamped by tools and welded by ionic plasma to make the cover 1 and the dispersing base 2 into a body in one-piece;

second polishing: the body composed of the cover 1 and dispersing base 2 is polished to remove the solder residual to smooth the surface of the body;

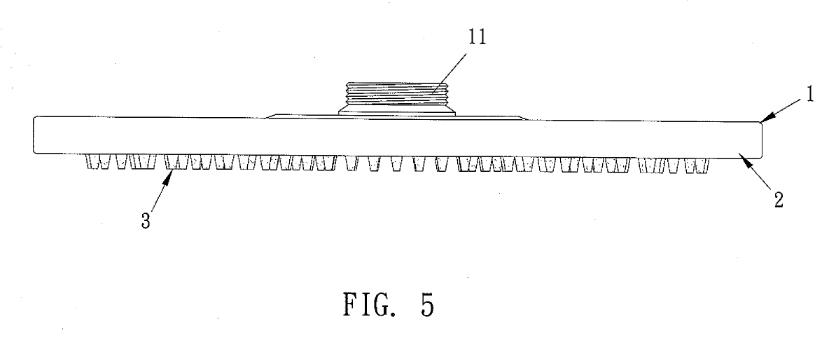

electroplating: the body composed of the cover 1 and dispersing base 2 is further electroplated to coat a metallic coating on its surface overall to obtain a seamless faucet as shown in FIGS. 4 and 5.

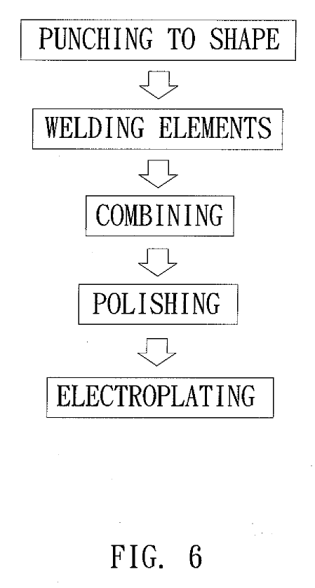

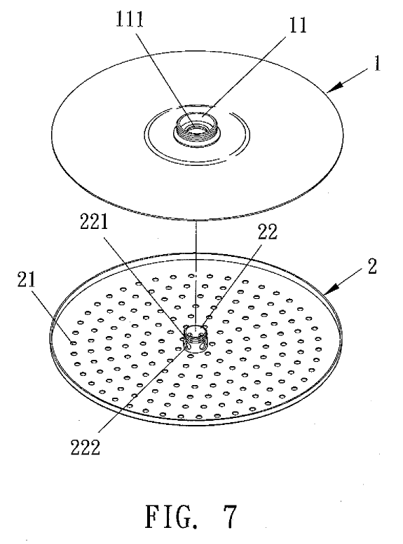

Additionally, as shown in FIGS. 6 and 7, another preferred embodiment of the manufacturing method has the following steps:

punching to shape: a cover 1 and a dispersing base 2 with multiple water holes 21 are shaped by punching respectively;

welding elements: a threaded connector 11 with an inner thread 111 is mounted on the cover 1 by welding and an insertion 22 with an outer thread 221 and multiple inlets 222 defined on its sidewall is mounted on the dispersing base 2 by welding;

combining: by screwing the outer thread 221 on the insertion 22 with the inner thread 111 on the threaded connector 11, the cover 1 and the dispersing base 2 are combined to achieve an initial combination and then clamped by tools and welded by ionic plasma to make the cover 1 and the dispersing base 2 into a body in one-piece;

polishing: the body composed of the cover 1 and dispersing base 2 is polished to remove the solder residual to smooth the surface of the body;

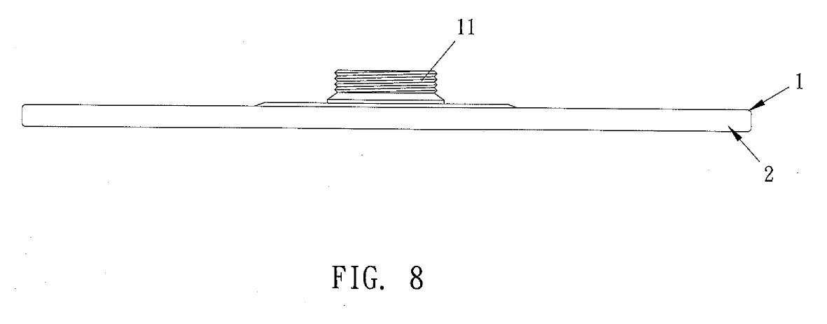

electroplating: the body composed of the cover 1 and dispersing base 2 is further electroplated to coat a metallic coating on its surface overall to obtain a seamless faucet as shown in FIG. 8 which has thinner thickness than the one of the seamless faucet in the foregoing embodiment.

The cover 1 and the dispersing base 2 are optionally shaped into round, rectangle or oval to create round, rectangular or oval seamless flat faucet.

According to above-mentioned preferred embodiments of the manufacturing method in the present invention, the seamless faucet comprises a cover 1 and a dispersing base 2. The cover 1 is made by punching and has a top face and a threaded connector 11 with an inner thread 111 mounted at a center of the top face of the cover 1 by welding. The dispersing base 2 is also made by punching and has a flat bottom with multiple water holes 21 and an insertion 22 with an outer thread 221 mounted at a center of the flat bottom. Moreover, the insertion 22 further has a sidewall and multiple inlets 222 defined on the sidewall. Polishing the dispersing base 2 and arranging the resilient pad 3 and the guiding plate 4 are carried out depending on manufacturer's needs. By engaging the inner and outer threads 111, 221 on the threaded connector 11 and the insertion 22, the cover 1 and the dispersing base 2 are combined and aligned. Then, the cover 1 and the dispersing base 2 are combined into a body in one-piece by welding. The body is further polished or electroplated the surface to achieve the seamless faucet in the present invention.

According to the above description of the preferred embodiments, the seamless faucet and its manufacturing method have the following advantages:

1. The cover 1 and the dispersing base 2 are shaped by punching respectively, combined by thread-screwing, and then combined into one-piece by welding so that the seamless faucet has low cost in respect of manufacture, raw material and processing procedure.

2. The seamless faucet made by the manufacturing processes as above has diminished size to have super thin and light weight.

3. After polishing and electroplating the body made of the cover 1 and the dispersing base 2, the seamless faucet has stylish and shinny appearance.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A manufacturing method of a seamless faucet comprising:
punching to shape a cover and a dispersing base respectively;
welding a threaded connector to mount on the cover and welding an insertion with multiple inlets to mount on the dispersing base;
polishing a surface of the dispersing base;
arranging a resilient pad and a guiding plate with multiple nozzles inside the dispersing base;
combining the cover and the dispersing base by thread-screwing the insertion with the threaded connector to achieve an initial combination, which is clamped by tools, and welding the cover and the dispersing base into a body in one-piece;
polishing the body composed of the cover and dispersing base;
electroplating the body composed of the cover and dispersing base to obtain the seamless faucet.

2. The manufacturing method of a seamless faucet comprising:
punching to shape a cover and a dispersing base respectively;
welding a threaded connector to mount on the cover and welding an insertion with multiple inlets to mount on the dispersing base;
combining the cover and the dispersing base by thread-screwing the insertion with the threaded connector to achieve an initial combination, which is clamped by tools, and welding the cover and the dispersing base into a body in one-piece;
polishing the body composed of the cover and dispersing base;
electroplating the body composed of the cover and dispersing base to obtain the seamless faucet.

3. A seamless faucet comprising:
a cover having a top surface and threaded connector welded to mount at a center of the top surface of the cover; and
a dispersing base having a top surface and an insertion welded to mount at a center of the top surface of the dispersing base to engage the threaded connector on the cover by thread-screwing for combination;
wherein the cover and the dispersing base are further welded to combine into a body in one-piece after combination and the body is further polished and electroplated.

4. The seamless faucet as claimed in claim 3, wherein a resilient pad and a guiding plate with multiple nozzles are arranged inside the dispersing base.

5. The seamless faucet as claimed in claim 3, wherein the threaded connector of the cover has an inner thread; and
the insertion of the dispersing base has an outer thread.

6. The seamless faucet as claimed in claim 3, wherein the insertion of the dispersing base further has a sidewall and multiple inlets defined on the sidewall.
